(19) United States
(12) Patent Application Publication
(10) Pub. No.: US 2009/0314845 A1
(43) Pub. Date: Dec. 24, 2009

(54) TEMPERATURE LIMITING DEVICE APPLICABLE TO SINGLE LEVER VALVES FOR MIXING HOT AND COLD LIQUIDS WITH AN IMPROVED INLET PORT

(75) Inventors: John William Green, Hamilton (NZ); Ian Morgan, Hamilton (NZ)

Correspondence Address: NIXON PEABODY, LLP, 401 9TH STREET, NW, SUITE 900, WASHINGTON, DC, 20004-2128, US

(73) Assignee: GREENS INDUSTRIES LIMITED, Hamilton (NZ)

(21) Appl. No.: 12/160,750

(22) PCT Filed: Jan. 5, 2007
(86) PCT No.: PCT/NZ07/00001

§ 371 Date: Jan. 2, 2009

(30) Foreign Application Priority Data
Jan. 11, 2006 (NZ) 544597

(51) Int. Cl. G05D 23/13

(52) U.S. Cl. 236/12.15

(57) ABSTRACT

A single lever valve for mixing hot and cold liquids has a mixer which can internally impose an upper limit on the temperature of any liquid emerging from it. The means used may enable the upper limit to be changed by exchange of a component so that the mixer can be used in any location in an installation even though different locations might have different upper limit requirements. The mixer may take the form of a cartridge able to be exchanged with an existing cartridge to convert an “unsafe” mixer to a “safe” one. There is a cylindrical mixing chamber with hot and cold liquid entry through ports through the side walls at opposite ends. A piston sealingly slidable within the chamber effects opening and closing of the ports.

### BACKGROUND

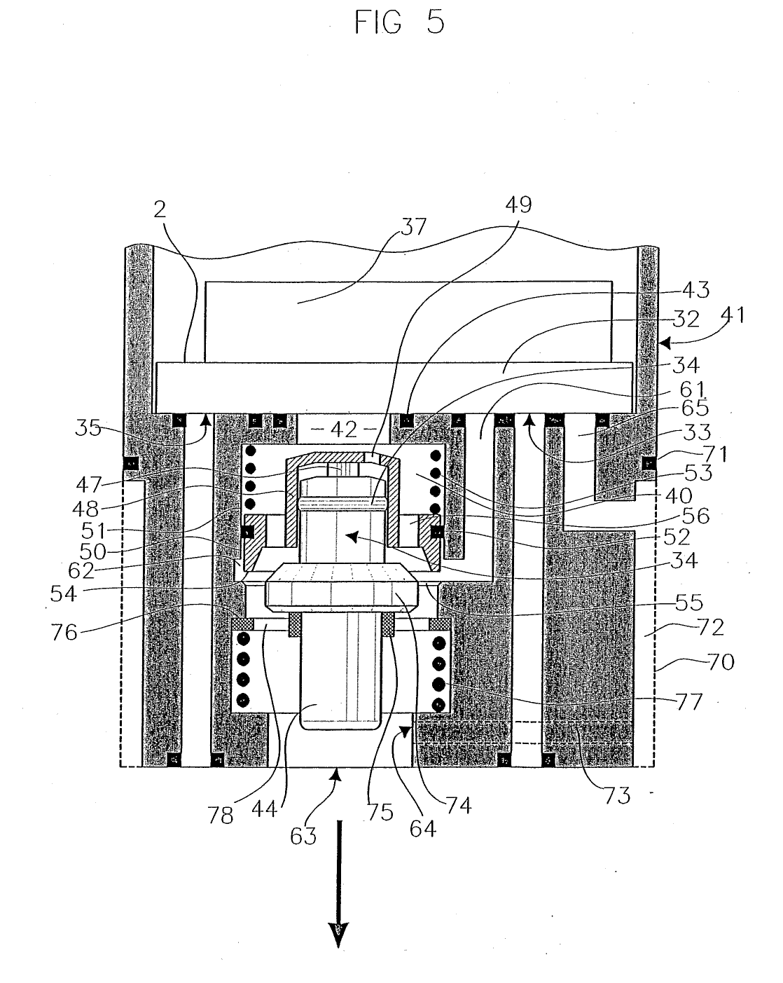

In our international patent application PCT/NZ2004/000225, published under W02005/028930 on 31 Mar. 2005, we described a temperature limiting device applicable to single lever valves for mixing hot and cold liquids. This invention relates to an improvement to the construction which is shown in FIG. 5 of that specification. The definitions in that specification are applicable to this and it is intended that the whole contents of that specification be treated as if repeated in this in order to enable the context of the present invention. One of the reasons for this improvement, when the earlier invention was applied to a cartridge, was to reduce the diameter of the cartridge to the standard 40 mm which is prevalent throughout Europe and elsewhere.

### PRIOR ART AND DESCRIPTION OF DRAWINGS

Referring to the aforementioned prior art FIG. 5, a copy of which is incorporated with this specification, hot liquid comes to the convergence space 40 via chamber inlet port 42. The chamber inlet port 42 is able to be closed by the cap 48 to restrain or prevent the hot liquid inflow under certain circumstances.

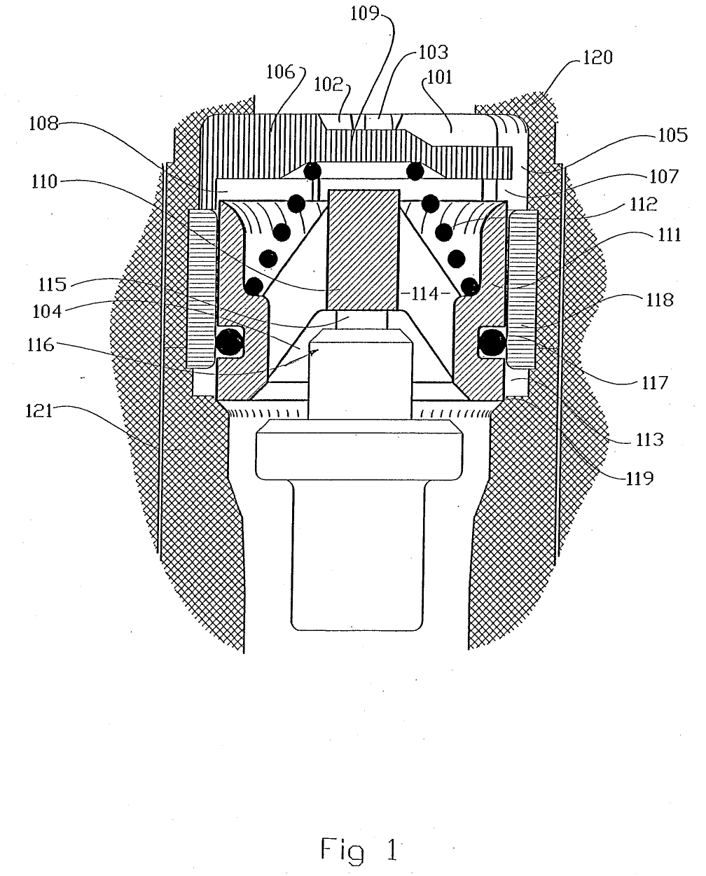

The present invention will shortly be described with reference to the accompanying schematic drawing labeled FIG. 1 which is a cross sectional view of modifications to the central part of the FIG. 5 arrangement.

Thus the present invention consists in an improvement to the invention claimed in PCT/NZ2004/000225 in that the convergence space has an axis and a substantially cylindrical wall coaxial with said axis; the flow regulating means includes a movable piston capable of moving within the cylindrical chamber defined by said cylindrical wall to slide to and fro in axial directions, there are sealing means to maintain a seal between the periphery of the piston and said cylindrical wall, there is an orifice through said piston which may offer communication between the hot and cold inlet passages; and where both the hot liquid inlet passage and the first cold liquid inlet passage communicate with said convergence space via or adjacent said cylindrical wall and said piston includes portions which may be positioned to effect complete closure of said hot inlet passage with full opening of said first cold liquid inlet passage and vice versa and in positions where there is partial opening/closure of both said passages.

### BEST MODE OF CARRYING OUT THE INVENTION

According to the present invention, the chamber inlet port no longer leads directly into the convergence space 40 from “above”. Instead there are one or more hot liquid inlet passages, preferably radial passages such as 101 and 102 which lead from the area 103 where the hot liquid enters the illustrated portion of the device, in use, towards the periphery of the convergence space 104. The passages such as 101 and 102 then extend “downwardly” through legs such as 105 and the means of entry into the convergence space 104 is at the side or sides of the convergence space through apertures or ports such as 107 and 108 which are also part of the hot liquid inlet passage(s). There may be six ribs such as 106 formed on the upper surface of the portion 109 and the spaces between these radial ribs form the passages 101, 102, etc. However, FIG. 1 shows an uneven number of ribs so that they could be better illustrated. The cap 110 replaces the previous cap 48 which had a restriction and sealing function and cap 110 now functions purely as a depth stop preventing damage to the parts of the flow regulating means which now effect closure of the side entry ports such as 107 and 108.

That closure is effected by means of a substantially cylindrical piston 111 which is normally biased by a compression spring 112 to a downward position where it effects closure of a circumferential “first” cold liquid inlet passage 113. Radial ribs such as 114 may be six in number and join the piston 111 to the cap 110. Thus when the piston 115 of a heated temperature sensing device 116 is thrust towards the portion 109 it lifts the cap 110 and with it the piston 111 to uncover the first cold liquid inlet passage 113 while closing off or restricting the hot liquid inlet passage(s).

O-ring 117 provides a seal to a wall insert part 118 of the device and the design achieves balanced hydraulic pressures above and below the O-ring with equal or uneven pressure hot and cold liquid supplies. The seal comes into play when either the hot liquid inlet passage or the first cold liquid inlet passage is closed to prevent leakage past the piston outer wall.

At the same time as the piston 111 is being raised, it restricts (or closes off) the hot liquid entry ports such as 107 and 108, to restrict the flow through them, and that restricted hot flow mingles with the cold liquid which has been admitted by unseating of the seal at the area 119 to provide cooling of the hot liquid inlet stream.

The arrangement is designed so that when the piston 111 has effected complete closure of the hot liquid entry ports 107 and 108 the cap 110 contacts the portion 109 to prevent any damage to the piston 111 which might lightly touch portion 109 and might be inherently resilient if made of a plastics material. The piston does not need to effect an absolutely leaktight seal for the device to operate properly.

The wall insert part 118 is matched in internal diameter to the external diameter of the piston 111. Once the portion 109 has been assembled in the first case portion 120 the wall insert 118 is positioned and holds the portion 109 in fixed position ultimately as second case portion 121 is added and secured.

| Ref | Item |
|---|---|
| 101 | Hot liquid inlet passage |
| 102 | Hot liquid inlet passage |
| 103 | Hot liquid entry area |
| 104 | Convergence space |
| 105 | Passage leg |
| 106 | Rib |
| 107 | Entry aperture/port |
| 108 | Entry aperture/port |
| 109 | Portion with ribs |
| 110 | Cap |
| 111 | Piston |
| 112 | Spring |
| 113 | First cold liquid inlet |
| 114 | Radial rib |
| 115 | Piston of 116 |
| 116 | Temperature sensing device |
| 117 | O ring |
| 118 | Wall insert |
| 119 | Seal |
| 120 | First case portion |
| 121 | Second case portion |
| 122 | |
| 123 | |
| 124 | |
| 125 | |

1-14. (canceled)

15. A device for mixing and regulating the output temperature of a hot liquid and a cold liquid, including:
a mixing chamber;
a hot liquid entry port into said chamber,
a first cold liquid entry port into said chamber,
an outlet from said chamber;
an outlet passage from the device which communicates with said chamber outlet;
mix proportioning means within said chamber able to alter the proportions of hot and cold liquids admitted through said entry ports into said chamber at any rate of combined output flow;
a temperature sensing device adapted to sense the temperature of the output of the mixed liquids from the chamber and to control the mix proportioning means so that the output temperature at all output flow rates from the chamber can never exceed, except for a small tolerance for a small time, a selected maximum; and
a second cold liquid entry port into the output passage of the device downstream from where the temperature of the output flow from the chamber is sensed,
characterized in that the mixing chamber has a cylindrical wall, the hot liquid entry port and the first cold liquid entry port into said chamber being at the side at or adjacent opposite ends of said cylindrical wall, said hot liquid entry port being part of a radially extending hot liquid inlet passage, and the mix proportioning means including joined sealing means slidable within the chamber under the control of the temperature sensing device so that as the cold liquid entry port into the chamber is progressively opened the hot liquid entry port is progressively closed and vice versa, the mix proportioning means enabling the following states of the device to be achieved:
the hot liquid entry port being completely closed while the first cold liquid entry port is completely open, and
the first cold liquid entry port being completely closed while the hot liquid entry port is completely open.

16. A device as claimed in claim 15, which includes a stationary distributing member and a movable distributing member, the stationary distributing member having ports to the movable distributing member for the supply of hot liquid and cold liquid to the movable distributing member, the movable distributing member regulating the proportions of hot and cold liquid supplied to the hot liquid entry port and to the cold liquid entry ports and the flow rates thereof, and enabling complete shut-off of all flows to said ports.

17. A device according to claim 16, further comprising a body supporting the distributing members, and sealing means to seal between parts of the movable and stationary distributing members, a hot liquid inlet port and said cold liquid inlet port being provided in the stationary distributing member, and a hot liquid transfer path and a cold liquid transfer path being provided in the movable distributing member; and further where all wholly or partly contained in the body, or all wholly or partly contained in the movable distributing member, or all wholly or partly contained in the stationary distributing member there is provided a convergence space, said hot liquid inlet passage communicating with said hot liquid transfer path and with said convergence space, a first cold liquid inlet passage communicating with said cold liquid transfer path and with said convergence space, an outlet from said convergence space, flow regulating means within the convergence space capable of regulating the flow of hot and cold liquids entering said convergence space by progressively opening the hot liquid inlet passage while progressively closing the first cold liquid inlet passage and vice versa and capable of effecting complete closure of said hot liquid inlet passage, said temperature sensing device which controls the operation of the flow regulating means in said outlet, a temperature sensing portion of said temperature sensing device, said second cold liquid inlet passage communicating with said cold liquid transfer path and with said outlet substantially downstream of said temperature sensing portion
and the movable distributing member being movable to each of the following positions: where the hot liquid inlet port communicates with the hot liquid transfer path which communicates with the hot liquid inlet passage and at the same time the cold liquid inlet port communicates with the cold liquid transfer path which communicates with the first cold liquid inlet passage; or where the hot liquid inlet port communicates with the hot liquid transfer path which communicates with the hot liquid inlet passage and at the same time the cold liquid inlet port communicates with the cold liquid transfer path which communicates with the first cold liquid inlet passage and the cold liquid transfer path also communicates with the second cold liquid inlet passage;
or where the hot liquid inlet port and the cold liquid inlet port do not communicate with each other and block communication from both said hot liquid inlet port and said cold liquid inlet port with any said passage; characterized in that the flow regulating means includes a piston in sealing but slidable contact with said cylindrical wall and the peripheral ends of the piston effect closure or opening of the hot liquid and first cold liquid inlet ports.

18. A device according to claim 17, wherein the convergence space has an axis, and a cylindrical wall coaxial with said axis and said flow regulating means includes a movable piston sealingly slidable to and fro in axial directions within said cylindrical wall, and there is an orifice through said piston which may offer communication between said hot and cold liquid inlet passages and wherein said first cold liquid inlet passage communicates with said convergence space at or adjacent one end of said cylindrical wall while said hot liquid inlet passage communicates with said convergence space at or adjacent the other end of said cylindrical wall and said piston may be positioned over said first cold liquid inlet passage to a position where said passage is completely closed so that, in use, no cold liquid can then enter said convergence space, while the hot liquid inlet passage is fully open and vice versa, and positions inbetween where both passages are partially open.

19. A device according to claim 15, wherein there are a plurality of hot liquid entry ports.

20. A device according to claim 16, wherein said cylindrical wall axis is parallel to an axis about which said mix proportioning means may be rotated.

21. A device according to claim 15, wherein said temperature sensing device expands on sensed liquid temperature increase and contracts on sensed liquid temperature decrease, in axial directions.

22. A control device according to claim 16, wherein said temperature sensing device includes a housing and a piston capable of being moved axially to and fro with respect to said housing, coaxially with said cylindrical wall axis.

23. A control device according to claim 22, wherein said temperature sensing device piston can directly contact said mix proportioning means piston.

24. A control device according to claim 23, wherein there is a resilient bias which biases said temperature sensing device piston to the most contracted position of the temperature sensing device.

25. A control device according to claim 24, wherein said resilient bias is a compression spring located between the upper end of said chamber and said flow regulating means piston.

26. A control device according to claim 17, wherein there is protection means for said temperature sensing device which prevents pressure above a pre-determined maximum pressure, being developed within said housing.

27. A control device according to claim 15, wherein the device is in the form a cartridge for a valve.

28. A control device according to claim 15, wherein the device is a valve and includes a single operating lever.
